(19) United States
(12) Patent Application Publication
(10) Pub. No.: US 2014/0081630 A1
(43) Pub. Date: Mar. 20, 2014

(54) METHOD AND APPARATUS FOR CONTROLLING VOLUME OF VOICE SIGNAL

(71) Applicant: Samsung Electronics Co. Ltd., Gyeonggi-do (KR)

(72) Inventor: Ji-Yeon Jung, Gyeonggi-do (KR)

(73) Assignee: Samsung Electronics Co., Ltd., Gyeonggi-do (KR)

(21) Appl. No.: 14/029,642

(22) Filed: Sep. 17, 2013

(30) Foreign Application Priority Data
Sep. 17, 2012 (KR) 10-2012-0102862

(51) Int. Cl. G10L 21/00

(52) U.S. Cl. CPC G10L 21/00
USPC 704/225

(57) ABSTRACT

A method for amplifying a voice signal in an electronic device. In the method, a voice signal received via a microphone is detected. When a volume of the detected voice signal is less than a predetermined average volume, the volume of the detected voice signal is amplified. The volume-amplified voice signal is transmitted.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Sep. 17, 2012 and assigned Serial No. 10-2012-0102862, the entire disclosure of which is hereby incorporated by reference.

### TECHNICAL FIELD

The present disclosure relates to a voice signal. More particularly, the present disclosure relates to a method and an apparatus for controlling the volume of a voice signal in an electronic device.

### BACKGROUND

Recently, as electronic devices such as a smart phone and a tablet Personal Computer (PC) develop rapidly, electronic devices enabling wireless voice communication and information exchange have become a daily necessity. In an early stage of distribution, the electronic device has been simply recognized as a portable device that enables wireless communication, but as a technology thereof develops and a wireless Internet is introduced, the electronic device gets out of the portable device enabling simple wireless communication and evolves into a multimedia device performing functions of schedule management, games, a remote controller, image shooting, a projector, etc., meeting a user's need. Accordingly, the electronic device has become a daily necessity.

Generally, when performing communication, a user of an electronic device controls a voice volume depending on a neighboring circumstance to perform communication. For example, in case of performing communication in a public space like a library, a subway, a bus, etc., the user lowers his voice volume and performs communication with a small volume. In this case, however, a user of a reception side has an inconvenience in performing communication due to voice of a small volume of the caller. Also, in the general electronic device, a user should directly manipulate a communication volume control key and control a transmission volume whenever the user performs communication. Therefore, a method for automatically controlling a transmission/reception volume in an electronic device depending on a user's circumstance needs to be provided.

### SUMMARY

To address the above-discussed deficiencies of the prior art, it is a primary aspect of the present disclosure to provide a method and an apparatus for controlling the volume of a voice signal in an electronic device.

Another aspect of the present disclosure is to provide a method and an apparatus for detecting an event for controlling the volume of a voice signal in an electronic device.

Another aspect of the present disclosure is to provide a method and an apparatus for controlling the volume of a voice signal by detecting an event during communication in an electronic device.

In accordance with an aspect of the present disclosure, a method for amplifying a voice signal in an electronic device is provided. The method includes detecting a voice signal received via a microphone, when a volume of the detected voice signal is less than a predetermined average volume, amplifying the volume of the detected voice signal, and transmitting the volume-amplified voice signal.

In accordance with another aspect of the present disclosure, an apparatus for amplifying a voice signal in an electronic device is provided. The apparatus includes one or more processors, a touch detect display, a microphone, a speaker, at least one sensor, a memory, and one or more programs stored in the memory and configured for execution by the one or more processors, wherein the program includes instructions for detecting a voice signal received via the microphone, when a volume of the detected voice signal is less than a predetermined average volume, amplifying the volume of the detected voice signal, and transmitting the volume-amplified voice signal.

Other aspects, advantages and salient features of the present disclosure will become apparent to those skilled in the art from the following detailed description, which, taken in conjunction with the annexed drawings, discloses certain embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a block diagram illustrating an electronic device for controlling the volume of a voice signal according to embodiments of the present disclosure;

FIG. 1B is a block diagram illustrating a processor of an electronic device for controlling the volume of a voice signal according to embodiments of the present disclosure;

FIG. 2 is a view illustrating an electronic device for controlling the volume of a voice signal according to embodiments of the present disclosure;

FIG. 3A is a flowchart illustrating a procedure for controlling the volume of a voice signal in an electronic device according to embodiments of the present disclosure;

FIG. 3B is a view illustrating components for controlling the volume of a voice signal in an electronic device according to embodiments of the present disclosure;

FIG. 4A is a flowchart illustrating a procedure for determining the average volume of a voice signal in an electronic device according to embodiments of the present disclosure;

FIG. 4B is a flowchart illustrating a procedure for amplifying the volume of a voice signal depending on the volume of the voice signal in an electronic device according to embodiments of the present disclosure;

FIG. 5 is a flowchart illustrating a procedure for detecting an event and amplifying the volume of a voice signal in an electronic device according to embodiments of the present disclosure;

FIG. 6 is a view illustrating an example for determining a user's microphone access using at least one sensor in an electronic device according to embodiments of the present disclosure;

FIG. 7 is a view illustrating an example for determining a user's speaker access using at least one sensor in an electronic device according to embodiments of the present disclosure; and

FIG. 8 is a view illustrating an example for determining the slope of an electronic device using at least one sensor in the electronic device according to embodiments of the present disclosure.

Throughout the drawings, like reference numerals will be understood to refer to like parts, components and structures.

### DETAILED DESCRIPTION

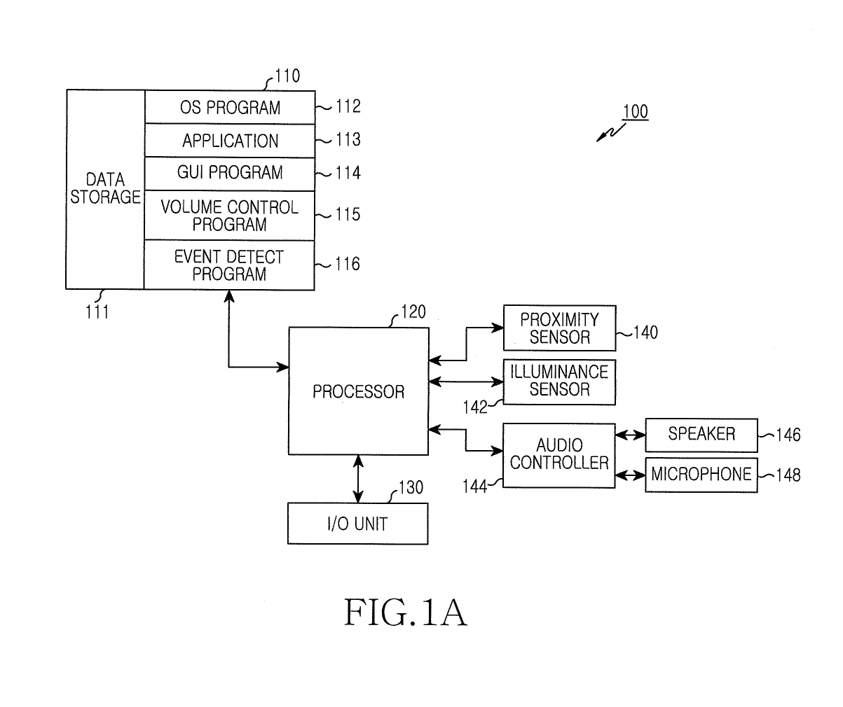

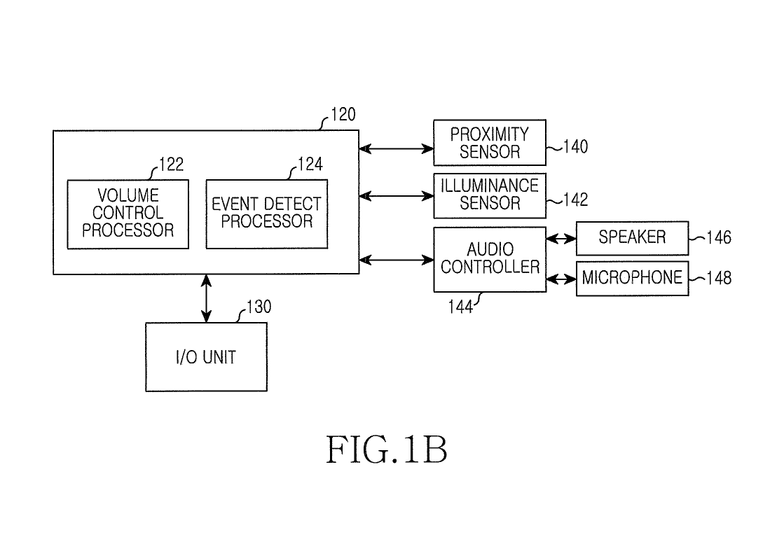

FIGS. 1A through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of certain embodiments of the present disclosure as defined by the claims and their equivalents. It includes various specific details to assist in that understanding but these are to be regarded as mere examples. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should he apparent to those skilled in the art that the following description of certain embodiments of the present disclosure are provided for illustration purpose only and not for the purpose of limiting the disclosure as defined by the appended claims and their equivalents.

In the following description, the electronic device includes a mobile communication terminal having a communication function, a smart phone, a tablet Personal Computer (PC), a feature phone, etc.

FIG. 1A is a block diagram illustrating an electronic device 100 for controlling the volume of a voice signal according to an embodiment of the present disclosure.

Referring to FIG. 1A, the electronic device 100 includes a memory 110, a processor 120, an Input/Output (I/O) unit 130, a proximity sensor 140, an illuminance sensor 142, and an audio controller 144. A plurality of memories 110 and processors 120 may be provided.

The memory 110 includes a data storage 111, an Operating System (OS) program 112, an application 113, a Graphic User Interface (GUI) program 114, a volume control program 115, an event detect program 116, etc. Also, since a program which is a software element can be expressed as a set of instructions, the program may be expressed as an instruction set. The program is also expressed as a module.

The memory 110 may store one or more programs including instructions performing an embodiment of the present disclosure.

The data storage 111 stores data occurring during execution of a function corresponding to a program stored in the memory 110. The data storage 111 according to the present disclosure may store the average volume of a voice signal determined by the volume control program 115. Also, the data storage 111 may store a threshold for determining whether an event of the event detect program 116 occurs. At this point, the threshold for determining whether the event occurs is a value obtained by experiment and may be set in advance. The threshold may be set and updated based on data obtained from at least one sensor provided to the electronic device 100 during a general mode communication. For example, a threshold distance may be set based on a distance between a proximity sensor 140 and a user detected by the proximity sensor 140. Threshold brightness may be set based on the brightness of light detected by a illuminance sensor 142. A threshold angle may be set based on the angle of the electronic device 100 detected by a gyro sensor (not shown).

The OS program 112 (for example, WINDOWS, LINUX, Dawin, RTXC, UNIX, OS X, or a built-in operating system such as VxWorks) includes various software elements for controlling a general system operation. For example, control of the general system operation denotes memory management and control, storage hardware (device) control and management, power control and management, etc. The OS program 112 performs a function for swift communication between various hardware (devices) and software elements (programs).

The application 113 includes applications such as a browser, an e-mail, a message, word processing, an address book, a widget, Digital Right Management (DRM), voice recognition, voice duplication, a position determining function, a location based service, communication, etc.

The GUI program 114 includes at least one software element for providing a user interface using graphics between a user and the electronic device 100. That is, the GUI program 114 includes at least one software element for displaying user interface information on the I/O unit 130. The GUI program 114 includes an instruction for displaying the volume amplify information of a voice signal on the I/O unit 130. For example, the GUI program 114 includes an instruction for displaying the volume information of a voice signal amplified by the volume control program 115 in the form of a state bar. For another example, the GUI program 114 includes an instruction for displaying the volume information of a voice signal amplified by the volume control program 115 in the form of an icon. For still another example, the GUI program 114 includes an instruction for displaying the volume information of a voice signal amplified by the volume control program 115 in the form of text. Also, the GUI program 114 includes an instruction for displaying an icon, a message, or an image representing the electronic device is operating in a mode (whisper mode) for automatically amplifying the volume of the voice signal on the I/O unit 130 when an event for controlling the volume of a voice signal is detected by the event detect program 116.

During communication, the volume control program 115 may determine the average volume of a voice signal received via a microphone 148. Specifically, the volume control program 115 measures the volume of a voice signal received via the microphone 148, and then determines the average volume of the measured volume. At this point, a method for determining the average volume of a voice signal may include at least one of a method for periodically measuring the volume of a voice signal via the microphone 148 during communication to determine an average volume, a method for receiving a voice signal during a specific section desired by a user and then determining the average volume of the received voice signal, a method for receiving voice signals at least one time during a predetermined period and then determining the average volume of the received voice signals, and a method for determining an average volume of user voice signals received under a voice signal receivable state excluding a communication state. Also, the volume control program 115 may determine the average volume of a voice signal received for each communication volume step. At this point, the communication volume represents a magnitude to which the volume of a voice signal received during communication is amplified. The voice signals received during communication may be amplified to different magnitudes depending on each step of the communication volume. The communication volume step may be divided into a plurality of steps depending on a design scheme, and the communication volume step of the electronic device 100 may be set and changed by a user's key manipulation or touch operation. The volume control program 115 may determine an average volume for each user received via the microphone 148 or determine an average volume of all users received via the microphone 148.

Also, during communication, the volume control program 115 receives a user's voice signal and then compares the volume of the received voice signal with a predetermined average volume. Here, the average volume may be one of the average volume of a communication volume step currently set in the electronic device 100, an average volume for a user of a voice signal, and the average volume of all users. When the volume of the received voice signal is greater than the predetermined average volume, the volume control program 115 determines a general mode as a communication mode to transmit the received voice signal according to the conventional communication scheme. At this point, the volume control program 115 amplifies the voice signal depending on the communication volume step set in the electronic device 100 and then controls a function for transmitting the voice signal to a counterpart electronic device. In contrast, when the volume of the received voice signal is less than the user's predetermined average volume, the volume control program 115 determines a whisper mode as the communication mode to amplify the volume of the received voice signal according to a predetermined scheme and transmit the voice signal. At this point, the volume control program 115 may amplify the volume of a voice signal according to the predetermined scheme regardless of the communication volume step set in the electronic device 100. The volume control program 115 can amplify the volume of a received voice signal to the predetermined average volume, amplify the volume of the received voice signal by a predetermined volume, and amplify the volume of the received voice signal to a volume or a ratio desired by the user under user control.

In addition, when a specific event is detected by the event detect program 116, the volume control program 115 compares the volume of a received voice signal with the predetermined average volume. When the volume of the received voice signal is greater than the predetermined average volume, the volume control program 115 determines the general mode as the communication mode to transmit the received voice signal according to the conventional communication scheme. In contrast, when the volume of the received voice signal is less than the predetermined average volume, the volume control program 115 determines the whisper mode as the communication mode to amplify the volume of the received voice signal according to a predetermined scheme and transmit the voice signal.

The event detect program 116 may determine whether a user communicates quietly via an event detected by at least one sensor. For example, the event detect program 116 may determine whether the user is separated apart from a speaker 146 via a proximity sensor 140 in the neighborhood of the speaker 146. For another example, the event detect program 116 may determine whether the user approaches the microphone 148 via a proximity sensor 140 in the neighborhood of the microphone 148. For still another example, the event detect program 116 may determine whether the user is separated from the speaker 146 via an illuminance sensor 142 in the neighborhood of the speaker 146. For still yet another example, the event detect program 116 may determine whether the user approaches the microphone 148 via an illuminance sensor 142 in the neighborhood of the microphone 148. For still yet another example, the event detect program 116 may determine whether the user is separated from the speaker 146 via an infrared sensor (not shown) in the neighborhood of the speaker 146. For further yet another example, the event detect program 116 may determine whether the user approaches the microphone 148 via an infrared sensor (not shown) in the neighborhood of the microphone 148. In addition, since generally the user performs communication with the electronic device 100 inclined by a predetermined angle or more in a situation where the user should communicate quietly, the event detect program 116 may determine whether the electronic device 100 is inclined by a threshold angle or more via an acceleration sensor (not shown) and a gyro sensor (not shown).

Though not shown, the processor 120 may include at least one processor and a peripheral interface. Also, the processor 120 executes a specific program (instruction set) stored in the memory 110 to perform a plurality of specific functions corresponding to the program.

The I/O unit 130 includes an input unit that can receive data and an output unit that can output data to provide an interface to a user. For example, the I/O unit 130 may be a touchscreen that can input and output data simultaneously. The I/O unit 130 may display volume amplify information of a voice signal and a related user interface.

The proximity sensor 140 may detect whether a user approaches. Particularly, the proximity sensor provided in the neighborhood of the speaker 146 may detect whether the user is separated apart from the speaker 146 in order to perform communication quietly. At this point, when a distance between the user (ex: the ear of the user) and the proximity sensor becomes greater than a threshold distance, a proximity sensor provided to the neighborhood of the speaker 146 may detect an event where the user is separated apart from the proximity sensor occurs. In contrast, when a distance between the user (ex: the mouse of the user) and the proximity sensor becomes closer than the threshold distance, a proximity sensor provided to the neighborhood of the microphone 148 may detect an event where the user approaches the proximity sensor occurs.

The illuminance sensor 142 may detect whether the user approaches depending on the brightness of detected light. Particularly, an illuminance sensor provided to the neighborhood of the speaker 146 may detect whether the user is separated apart from the speaker 146 in order to in order to perform communication quietly. At this point, when the brightness of the light in the neighborhood of the speaker 146 gets brighter than threshold illuminance, the illuminance sensor may detect an event where the user is separated apart from the illuminance sensor occurs. In contrast, an illuminance sensor provided to the neighborhood of the microphone 148 may detect whether the user approaches the microphone 148 in order to perform communication quietly. At this point, when the brightness of the light in the neighborhood of the microphone 148 gets darker than threshold illuminance, the illuminance sensor may detect an event where the user approaches the illuminance sensor occurs.

The audio controller 144 is coupled to the speaker 146 and the microphone 148 to perform voice recognition, voice duplication, digital recording, and a function of inputting and outputting an audio stream such as a telephone function. That is, the audio controller 144 performs the function for outputting an audio signal via the speaker 146 and receiving the user's voice signal via the microphone 148. The audio controller 144 receives a data stream via the processor 120, converts the received data stream to an electric stream, and then transfers the converted electric stream (electric signal) to the speaker 146. The audio controller 144 receives a converted electric stream from the microphone 148, converts the received electric stream to an audio data stream, and then transmits the converted audio data stream to the processor 120. The audio controller 144 may include an attachable and detachable ear phone, a head phone, or a head set. The speaker 146 converts an electric stream received from the audio controller 144 to a sound wave audible by a human being and outputs the same. The microphone 148 converts a sound wave transferred from a human being or other sound sources to an electric stream. The audio controller 144 amplifies the volume of a voice signal input from the microphone 148 using the volume control program 115.

FIG. 1B is a block diagram illustrating a processor of an electronic device for controlling the volume of a voice signal according to embodiments of the present disclosure.

Referring to FIG. 1B, the processor 120 includes the volume control processor 122 and the event detect processor 124. During communication, the volume control processor 122 may determine the average volume of a voice signal received via the microphone 148. Specifically, during communication, the volume control processor 122 measures the volume of a voice signal received via the microphone 148, and then determines the average volume of the measured volume. At this point, during communication, the volume control processor 122 may use a method for periodically measuring the volume of a voice signal received via the microphone 148 and determining the average volume during communication, a method for receiving a voice signal during a specific time section desired by a user and then determining the average volume of the received voice signal, a method for receiving voice signals one or more times for a predetermine period and then determining the average volume of the received voice signals, and a method for determining the average volume of a user's voice signal received under a voice signal receivable state excluding a communication state.

Also, the volume control processor 122 may determine the average volume of a voice signal received for each communication volume step. At this point, the communication volume represents a magnitude to which the volume of a voice signal received during communication is amplified. A voice signal received during communication may be amplified to different magnitudes depending on each step of the communication volume. The communication volume may be divided into a plurality of steps depending on a design scheme, and the communication volume step of the electronic device 100 may be set and changed by a user's key manipulation or touch operation. The volume control processor 122 may determine an average volume for each user received via the microphone 148 or determine an average volume of all users received via the microphone 148.

Also, during communication, the volume control processor 122 receives a user's voice signal and then compares the volume of the received voice signal with the predetermined average volume. When the volume of the received voice signal is greater than the predetermined average volume, the volume control processor 122 determines the general mode as the communication mode to transmit the received voice signal according to the conventional communication scheme. At this point, the volume control processor 122 amplifies the voice signal according to the communication volume step set in the electronic device 100, and then controls a function for transmitting the voice signal to a counterpart electronic device. In contrast, when the volume of the received voice signal is less than the user's predetermined average volume, the volume control processor 122 determines the whisper mode as the communication mode to amplify the volume of the received voice signal according to a predetermined scheme and transmit the voice signal. At this point, the volume control processor 122 may amplify the volume of the voice signal according to the predetermined scheme regardless of the communication volume step set in the electronic device 100. The volume control processor 122 may amplify the volume of the received voice signal to the predetermined average volume, and amplify the volume of the received voice signal by the predetermined volume, and amplify the volume of the received voice signal to a volume or a ratio desired by the user under user control.

In addition, when a specific event is detected by the event detect processor 124, the volume control processor 122 compares the volume of the received voice signal with the predetermined average volume. When the volume of the received voice signal is greater than the predetermined average volume, the volume control processor 122 determines the general mode as the communication mode to transmit the received voice signal according to the conventional communication scheme. In contrast, when the volume of the received voice signal is less than the predetermined average volume, the volume control processor 122 determines the whisper mode as the communication mode to amplify the volume of the received voice signal according to a predetermined scheme and transmit the voice signal.

The event detect processor 124 may determine whether a user communicates quietly via an event detected by at least one sensor. For example, the event detect processor 124 may determine whether the user is separated apart from the speaker 146 via at least one of the proximity sensor 140, the illuminance sensor 142, and the infrared sensor (not shown) in the neighborhood of the speaker 146. For another example, the event detect processor 124 may determine whether the user approaches the microphone 148 via at least one of the proximity sensor 140, the illuminance sensor 142, and the infrared sensor (not shown) in the neighborhood of the microphone 148. For still another example, the event detect processor 124 may determine whether the electronic device is inclined by a threshold angle or more via at least one of the acceleration sensor (not shown) and the gyro sensor (not shown).

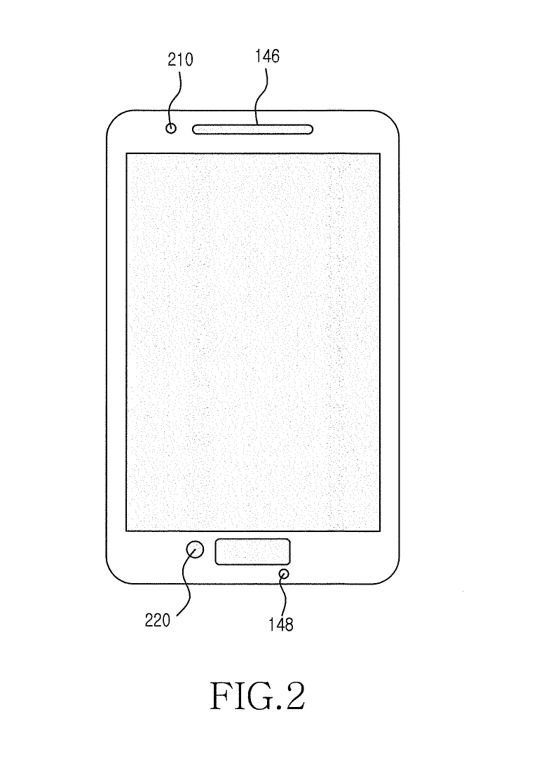

FIG. 2 illustrates an electronic device for controlling the volume of a voice signal according to embodiments of the present disclosure.

Referring to FIG. 2, the electronic device has one or more sensors 210 and 220 in the neighborhood of the speaker 146 and the microphone 148. At this point, the provided one or more sensors 210 and 220 may be one or more sensors of a proximity sensor, an illuminance sensor, an infrared sensor, an acceleration sensor, and a gyro sensor for detecting a user's approach. Particularly, during communication, the sensor 210 in the neighborhood of the speaker 146 may determine whether the user is separated apart from the speaker 146. During communication, the sensor 220 in the neighborhood of the microphone 148 may determine whether the user approaches the microphone 148. At this point, the electronic device 100 may have only one of the sensor 210 in the neighborhood of the speaker 146 and the sensor 220 in the neighborhood of the microphone 148, and may have both sensors when needed.

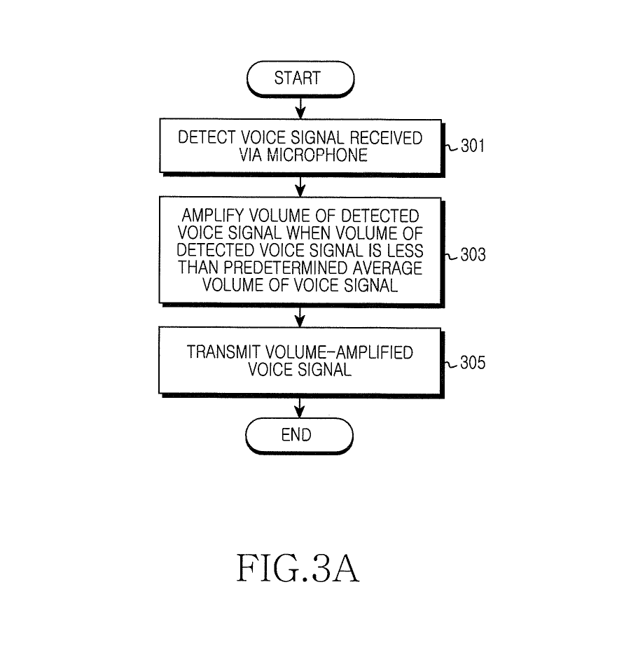

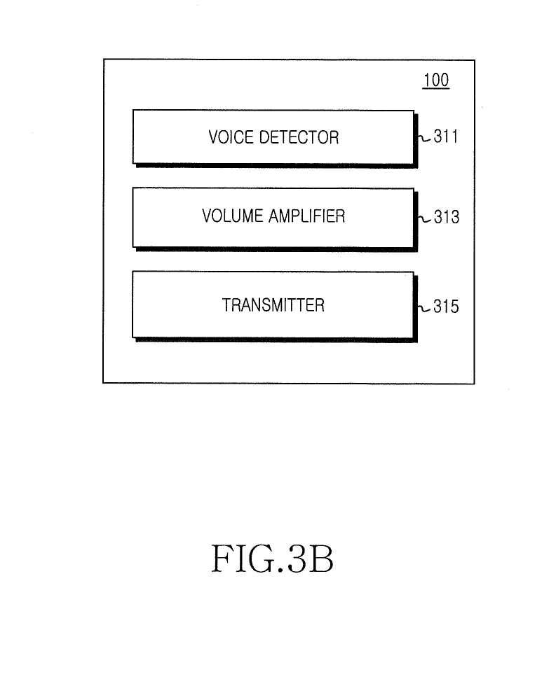

FIG. 3A illustrates a procedure for controlling the volume of a voice signal in an electronic device according to embodiments of the present disclosure.

Referring to FIG. 3A, the electronic device 100 detects a voice signal received via the microphone 148 in operation 301. After that, when the volume of the detected voice signal is less than the predetermined average volume of a voice signal, the electronic device 100 amplifies the volume of the detected voice signal. At this point, during communication, the average volume of the voice signal may be determined using a method for periodically measuring the volume of the user's voice signal received via the microphone 148 to determine the average volume, a method for receiving a voice signal at a specific point desired by the user and then determining the average volume of the received voice signal, a method for receiving the user's voice signal at least one time and then determining the average volume of the received voice signal, and a method for determining the average volume of the user's voice signal received under a user voice signal receivable state excluding communication. Also, in case of amplifying the volume of the detected voice signal, the electronic device 100 may amplify the volume of a voice signal received via the microphone 148 to the average volume, amplify the volume of the voice signal by the predetermined volume, and amplify the volume of the voice signal to a volume or a ratio desired by the user under user control.

After that, the electronic device proceeds to operation 305 to transmit the volume-amplified voice signal.

FIG. 3B illustrates components for controlling the volume of a voice signal in an electronic device according to embodiments of the present disclosure.

Referring to FIG. 3B, the electronic device 100 includes voice detector 311 configured to detect a voice signal received from the microphone 148. Also, the electronic device 100 includes volume amplifier 313 configured to amplify the volume of the detected voice signal when the volume of the detected voice signal is less than the predetermined average volume of a voice signal. In addition, the electronic device 100 includes transmitter 315 configured to transmit the volume-amplified voice signal.

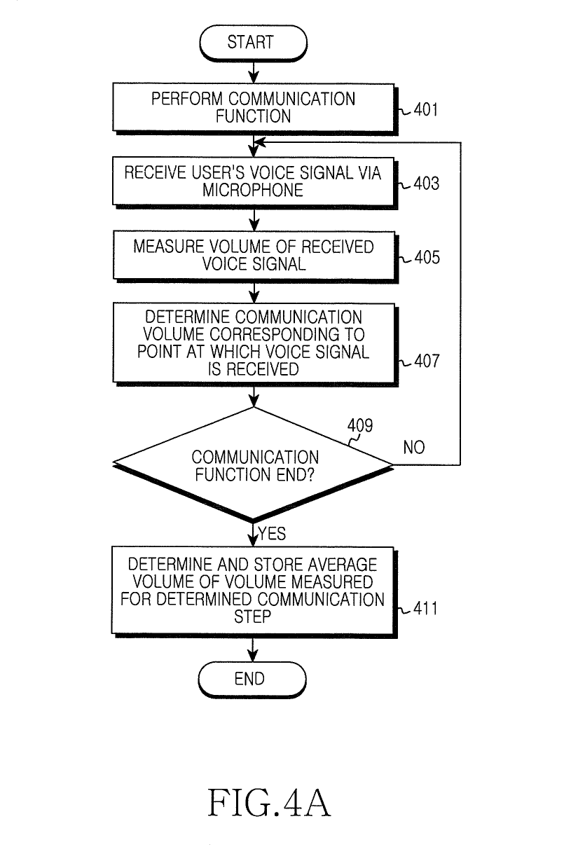

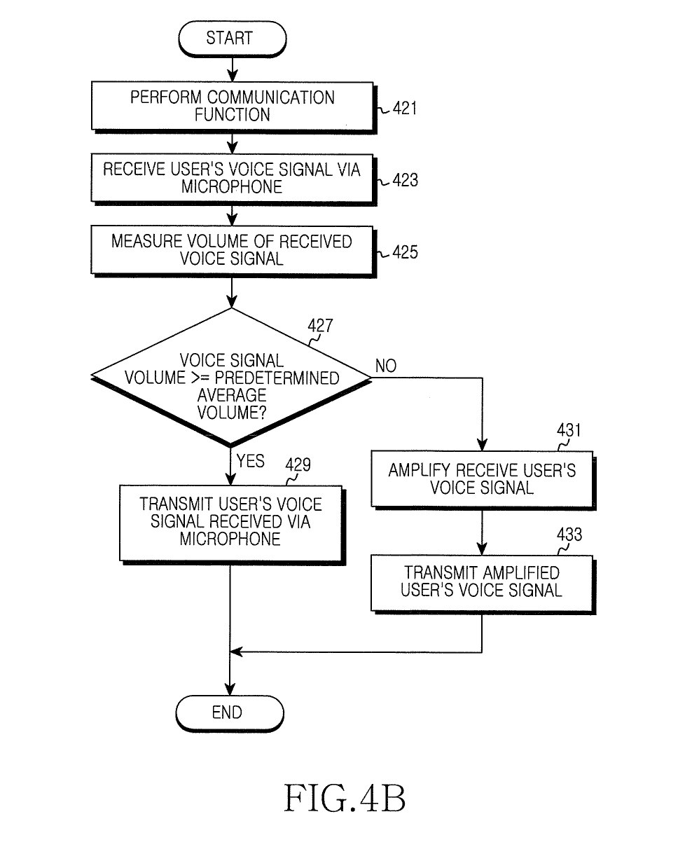

FIG. 4A illustrates a procedure for determining the average volume of a voice signal in an electronic device according to embodiments of the present disclosure.

Referring to FIG. 4A, the electronic device 100 performs a communication function in operation 401, and proceeds to operation 403 to receive a user's voice signal via the microphone 148. After that, the electronic device 100 proceeds to operation 405 to measure the volume of the received voice signal. At this point, the electronic device 100 may measure the volume of the received voice signal in real-time. After that, the electronic device 100 proceeds to operation 407 to determine a communication volume corresponding to a point at which the voice signal has been received. At this point, the communication volume represents an amplify magnitude for the volume of a voice signal received during communication. The voice signals received during communication may be amplified to different magnitudes depending on each step of the communication volume. The communication volume step of the electronic device 100 may be set by a user's key manipulation or touch operation. After that, the electronic device 100 proceeds to operation 409 to determine whether a communication function ends.

When the communication function does not end, the electronic device 100 returns to operation 403 to re-perform subsequent operations.

In contrast, when the communication function ends, the electronic device 100 proceeds to operation 411 to determine the average volume of a voice signal received in real-time using the volume measured in real-time, and store the determined volume as the average volume for the determined communication volume step. For example, in the case where the communication volume is divided into a first step to a fifth step, when the communication volume of the electronic device 100 is a third step, the electronic device 100 measures an average volume for voice signals received while the communication volume is the third step and stores the measured average volume as the average volume of the third step. When the communication volume is the first step, the electronic device measures an average volume for voice signals received while the communication volume is the first step and stores the measured average volume as the average volume of the first step. After that, the electronic device 100 ends the procedure.

Though the method for determining the average volume of voice signals received for each communication volume step has been described in the above description, the present disclosure is not limited thereto and a method for determining the average of received voice signals regardless of the communication volume may be performed.

FIG. 4B illustrates a procedure for amplifying the volume of a voice signal depending on the volume of the voice signal in an electronic device according to embodiments of the present disclosure.

Referring to FIG. 4B, the electronic device 100 performs a communication function in operation 421, and then proceeds to operation 423 to receive a user's voice signal via the microphone 148. After that, the electronic device 100 proceeds to operation 425 to measure the volume of the received voice signal. At this point, the electronic device 100 may measure the volume of the received voice signal in real-time. After that, the electronic device 100 proceeds to operation 427 to determine whether the volume of the received voice signal is greater than the predetermined average volume. Here, the average volume may be one of an average volume of a communication volume step currently set in the electronic device 100, an average volume for a user of a voice signal, and an average volume of all users.

When the volume of the received voice signal is greater than the predetermined average volume, the electronic device 100 proceeds to operation 429 to transmit the user's voice signal received via the microphone. In other words, when the volume of the received voice signal is greater than the predetermined average volume, the electronic device 100 performs the conventional communication function and then ends the procedure. At this point, the voice signal may be amplified depending on a communication volume step set in the electronic device 100 and transmitted to a counterpart electronic device.

In contrast, when the volume of the received voice signal is less than the predetermined average volume, the electronic device 100 proceeds to operation 431 to amplify the received user's voice signal. At this point, the electronic device 100 may amplify the volume of the voice signal according to the predetermined scheme regardless of the communication volume step set in the electronic device 100. The electronic device 100 may amplify the volume of a received voice signal to an average volume, amplify the volume of the received voice signal by a predetermined volume, and amplify the volume of the received voice signal to a volume or a ratio desired by the user under user control. After that, the electronic device 100 proceeds to operation 433 to transmit the amplified user's voice signal and then ends the procedure.

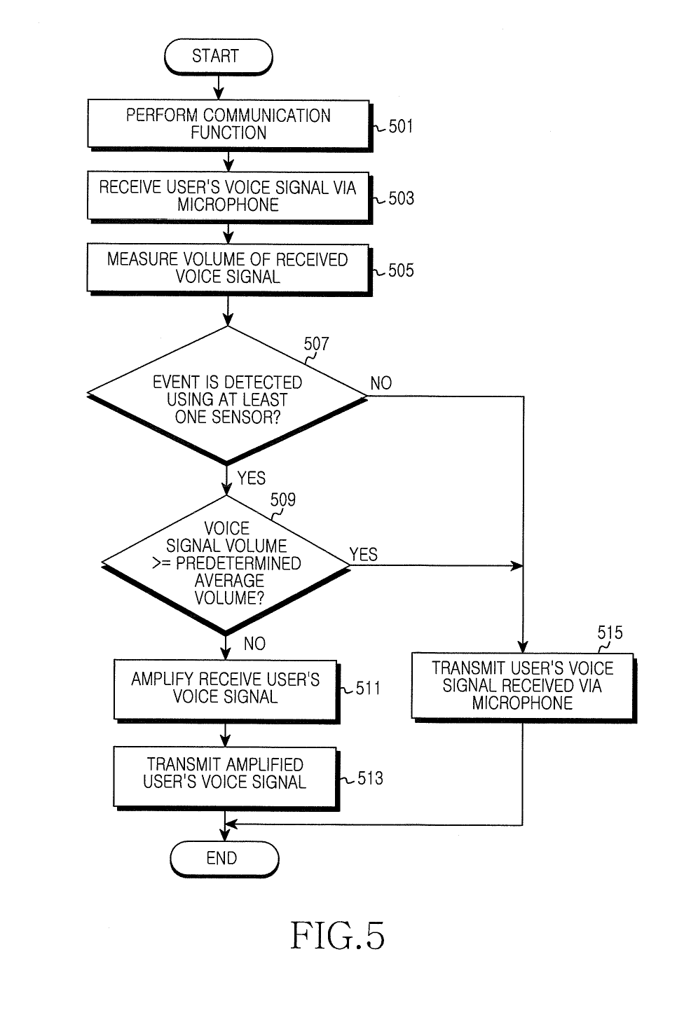

FIG. 5 illustrates a procedure for detecting an event and amplifying the volume of a voice signal in an electronic device according to embodiments of the present disclosure.

Referring to FIG. 5, the electronic device 100 performs a communication function in operation 501, and then proceeds to operation 503 to receive a user's voice signal via the microphone 148. After that, the electronic device 100 proceeds to operation 505 to measure the volume of the received voice signal. At this point, the electronic device 100 may measure the volume of the received voice signal in real-time.

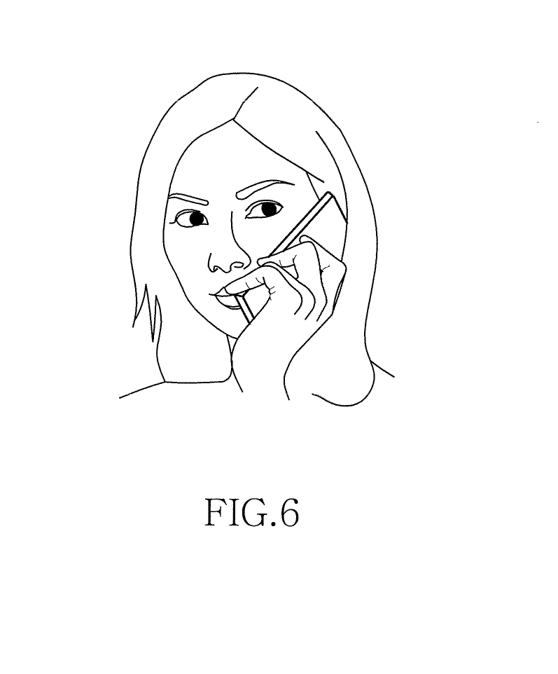

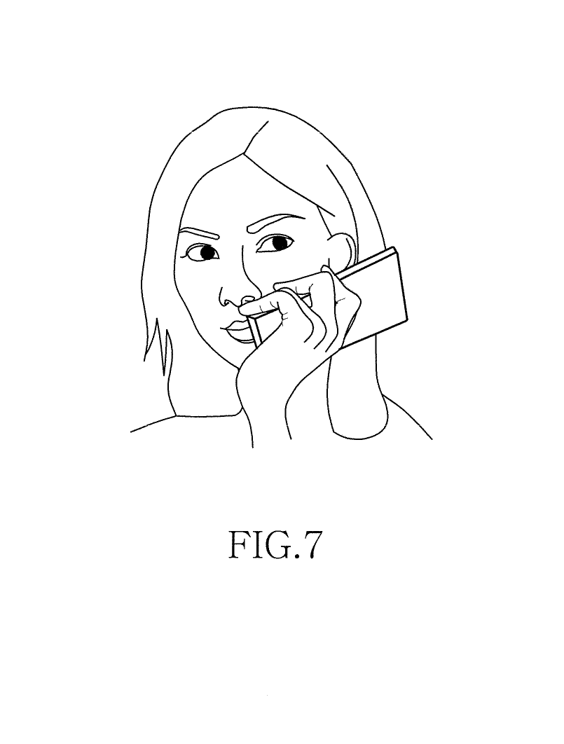

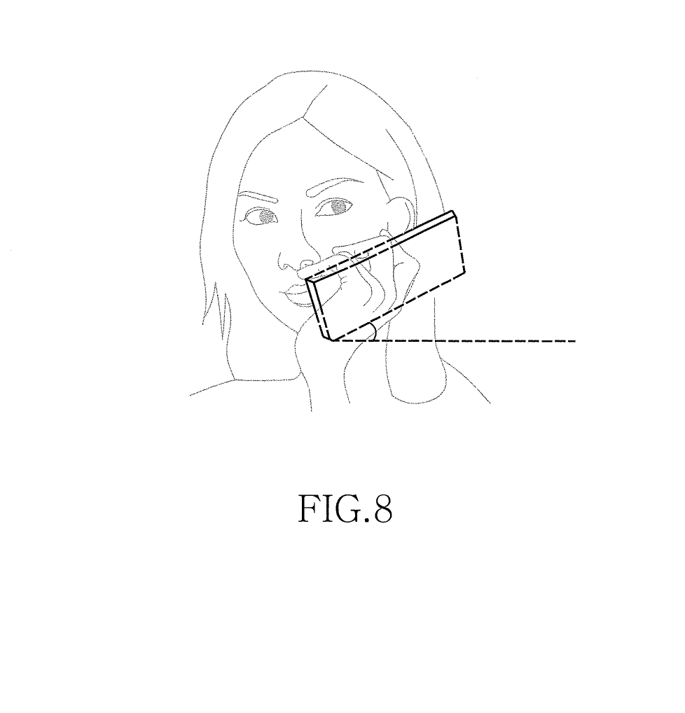

After that, the electronic device 100 proceeds to operation 507 to determine whether an event is detected using at least one sensor. Generally, in the case where the user performs communication under a quiet circumstance, as illustrated in FIG. 6, the user communicates with his or her mouth positioned near the microphone 148, or as illustrated in FIG. 7, the user communicates with his or her ears separated apart from the speaker 146, or as illustrated in FIG. 8, the user communicates with the electronic device 100 inclined by a predetermined angle or more. Accordingly, the electronic device 100 determines whether an event where the user approaches the microphone 148, an event where the user is separated apart from the speaker 146, and an event where the electronic device 100 is inclined by a predetermined angle or more occur using at least one sensor. Here, the at least one sensor includes the proximity sensor 140, the illuminance sensor 142, the infrared sensor (not shown), the acceleration sensor (not shown), the gyro sensor (not shown), etc. For example, the electronic device 100 may detect whether the user is separated apart from the speaker 146 in order to communicate quietly using the proximity sensor 140 in the neighborhood of the speaker 146. At this point, when the user is separated apart from the proximity sensor 140 in the neighborhood of the speaker 146 by a threshold distance, the electronic device 100 can detect an event where the user is separated apart from the proximity sensor 140 occurs. For another example, the electronic device 100 can detect whether the user approaches the microphone 148 in order to communicate quietly using the proximity sensor 140 in the neighborhood of the microphone 148. At this point, when the user approaches the microphone 148 within a threshold distance of the proximity sensor 140 in the neighborhood of the microphone 148, the electronic device 100 can detect an event where the user approaches the proximity sensor 140 occurs. For still another example, the electronic device 100 can detect whether the user is separated apart from the speaker 146 in order to communicate quietly using the illuminance sensor 142 in the neighborhood of the speaker 146. At this point, when the brightness of light in the neighborhood of the speaker 146 gets brighter than threshold illuminance, the electronic device 100 can detect an event where the user is separated apart from the illuminance sensor 142 occurs. For yet another example, the electronic device 100 can detect whether the user approaches the microphone 148 in order to communicate quietly using the illuminance sensor 142 in the neighborhood of the microphone 148. At this point, when the brightness of light in the neighborhood of the microphone 148 gets darker than threshold illuminance, the electronic device 100 can detect an event where the user approaches the illuminance sensor 142 occurs. For yet still another example, the electronic device 100 can determine whether the electronic device 100 is inclined by a threshold angle or more via the acceleration sensor (not shown) and the gyro sensor (not shown). At this point, when the electronic device 100 is inclined by the threshold angle or more, the electronic device 100 can detect an event where the user takes an action in order to communicate quietly occurs.

When detecting an event using at least one sensor, the electronic device 100 proceeds to operation 509 to determine whether the volume of a received voice signal is greater than a predetermined average volume. Here, the average volume may be one of the average volume of a communication volume step currently set in the electronic device 100, an average volume for a user of a voice signal, and the average volume of all users. When the volume of the received voice signal is less than the predetermined average volume, the electronic device 100 proceeds to operation 511 to amplify a user's voice signal. At this point, the electronic device 100 can amplify the volume of the voice signal according to a predetermined scheme regardless of the communication volume step set in the electronic device 100. The electronic device 100 can amplify the volume of the received voice signal to the average volume, amplify the volume of the received voice signal by a predetermined volume, and amplify the volume of the received voice signal to a volume or a ratio desired by the user under user control. After that, the electronic device 100 proceeds to operation 513 to transmit the amplified user's voice signal and then ends the procedure.

In contrast, when the volume of the received voice signal is greater than the predetermined average volume, the electronic device 100 proceeds to operation 515 to transmit the user's voice signal received via the microphone. In other words, when not detecting an event using the at least one sensor, the electronic device 100 performs the conventional communication function, and then ends the procedure. At this point, the voice signal may be amplified according to the communication volume step set in the electronic device 100 and then transmitted to a counterpart electronic device.

In contrast, when not detecting an event using the at least one sensor in operation 507, the electronic device 100 proceeds to operation 515 to transmit a user's voice signal received via the microphone, and then ends the procedure.

Though the method for detecting an event using the at least one sensor in operation 507 and when the volume of a received voice signal is less than the predetermined average volume in operation 509, amplifying the volume of the received voice signal has been described in the above description, the present disclosure is not limited thereto and the sequence of operation 507 and operation 509 can be changed to a method for, when the volume of the received voice signal is less than the average volume, determining whether an event is detected using the at least one sensor, and amplifying the volume of the received voice signal may be applied.

Though whether to amplify the volume of a voice signal is determined using the average volume of the voice signal input from the microphone 148 in the above description, whether to amplify the volume of the voice signal may be determined using a predetermined threshold volume. Also, in the above description, in the case where the volume of a voice signal is less than the predetermined average volume, when an event is detected via the at least one sensor, the electronic device operates in the whisper mode to amplify the volume of the voice signal. However, even in the case where the volume of a voice signal is not less than the predetermined average volume, when an event is detected using the at least one sensor, the electronic device may operate in the whisper mode to amplify the volume of the voice signal.

Embodiments and functional operations of the present disclosure described in the specification may be implemented in computer software, firmware, hardware, or a combination of one or more of these including the structure disclosed in the present specification and equivalents thereof. Also, the embodiments according to the present disclosure may be executed by one or more computer program products, a data processing device, or one or more modules of computer program instructions encoded on a computer readable medium for controlling an operation of the device.

The computer readable medium may be a machine readable storage medium, a machine readable storage substrate, a memory unit, a construction of a material having an influence on a machine readable electromagnetic wave stream, or a combination of these. A terminology of the data processing device includes a programmable processor, a computer, or all apparatuses, devices, and machines for processing data including multiple processors or a computer, for example. An apparatus may include a code added to a hardware and generating an execution environment for a relevant computer program, for example, a code forming a processor firmware, a protocol stack, a database management system, an Operating System (OS), or a combination of one or more of these.

Although the present disclosure has shown and described with reference to certain embodiments, it will be understood by those skilled in the art that various changes in form and details may be made without departing from the spirit and scope of the disclosure as defined by the appended claims and their equivalents. Therefore, the scope of the present disclosure should not be limited to the above-described embodiments but should be determined by the appended claims and equivalents thereof.

What is claimed is:

1. A method for amplifying a voice signal in an electronic device, the method comprising:
detecting a voice signal received via a microphone;
when a volume of the detected voice signal is less than a predetermined average volume, amplifying the volume of the detected voice signal; and
transmitting the volume-amplified voice signal.

2. The method of claim 1, further comprising:
determining an average volume of the voice signal received via the microphone.

3. The method of claim 1, wherein the amplifying comprises:
amplifying the volume of the detected voice signal using at least one of the predetermined average volume of the voice signal, a predetermined volume, and a volume or a ratio desired by a user under user control.

4. The method of claim 1, further comprising:
determining whether a user approaches via at least one sensor; and
determining whether the volume of the detected voice signal is less than an average volume of a voice signal measured in advance depending on whether the user approaches.

5. The method of claim 4, wherein the sensor comprises at least one of a proximity sensor, an illuminance sensor, an infrared sensor, an acceleration sensor, and a gyro sensor.

6. The method of claim 5, wherein when the sensor comprises the proximity sensor, determining whether the user approaches via the at least one sensor comprises:
determining whether a distance between the user and a speaker is separated by a predetermined threshold distance or more via the proximity sensor.

7. The method of claim 5, wherein when the sensor comprises the proximity sensor, determining whether the user approaches via the at least one sensor comprises:
determining whether a distance between the user and a microphone reduces within a predetermined threshold distance via the proximity sensor.

8. The method of claim 5, wherein when the sensor comprises the illuminance sensor, determining whether the user approaches via the at least one sensor comprises:
determining whether brightness of detected light gets equal to or brighter than predetermined threshold brightness via the illuminance sensor.

9. The method of claim 5, wherein when the sensor comprises the illuminance sensor, determining whether the user approaches via the at least one sensor comprises:
determining whether brightness of detected light gets equal to or darker than predetermined threshold brightness via the illuminance sensor.

10. The method of claim 1, further comprising:
measuring an angle of the electronic device via at least one sensor; and
determining whether the measured angle of the electronic device is equal to or greater than a threshold angle.

11. An electronic device for amplifying a voice signal, the electronic device comprising:
one or more processors;
a touch detect display;
a microphone;
at least one sensor;
a memory; and
one or more programs stored in the memory and configured for execution by the one or more processors,
wherein the program comprises instructions for detecting a voice signal received via the microphone, when a volume of the detected voice signal is less than a predetermined average volume, amplifying the volume of the detected voice signal, and transmitting the volume-amplified voice signal.

12. The electronic device of claim 11, wherein the program further comprises:
an instruction for determining an average volume of the voice signal received via the microphone.

13. The electronic device of claim 11, wherein the program further comprises an instruction for amplifying the volume of the detected voice signal using at least one of the predetermined average volume of the voice signal, a predetermined volume, and a volume or a ratio desired by a user under user control.

14. The electronic device of claim 11, wherein the program further comprises an instruction for determining whether a user approaches via at least one sensor, and then determining whether the volume of the detected voice signal is less than an average volume of a voice signal measured in advance depending on whether the user approaches.

15. The electronic device of claim 11, wherein the at least one sensor comprises at least one of a proximity sensor, an illuminance sensor, an infrared sensor, an acceleration sensor, and a gyro sensor.

16. The electronic device of claim 15, further comprising a speaker, wherein when the sensor is the proximity sensor, the program further comprises an instruction for determining whether a distance between the user and the speaker is separated by a predetermined threshold distance or more via the proximity sensor.

17. The electronic device of claim 15, wherein when the sensor is the proximity sensor, the program further comprises an instruction for determining whether a distance between the user and the microphone reduces within a predetermined threshold distance via the proximity sensor.

18. The electronic device of claim 15, further comprising a speaker,
wherein when the sensor comprises the illuminance sensor, the program further comprises an instruction for determining whether brightness of detected light gets equal to or brighter than predetermined threshold brightness via the illuminance sensor.

19. The electronic device of claim 15, wherein when the sensor comprises the illuminance sensor, the program further comprises an instruction for determining whether brightness of detected light gets equal to or darker than predetermined threshold brightness via the illuminance sensor.

20. The electronic device of claim 11, wherein when the sensor comprises at least one of the acceleration sensor and the gyro sensor, the program further comprises an instruction for measuring an angle of the electronic device via at least one sensor, and determining whether the measured angle of the electronic device is equal to or greater than a threshold angle.
